(19) United States
(12) Patent Application Publication
(10) Pub. No.: US 2012/0068582 A1
(43) Pub. Date: Mar. 22, 2012

(54) JEWELRY CABINET

(75) Inventors: Debra K. ELDERKIN, Pompano Beach, FL (US); Rachel N. COLOSIMO, Cleveland Heights, OH (US); John R. NOTTINGHAM, Bratenahl, OH (US); Jeffrey M. KALMAN, Cleveland Heights, OH (US)

(73) Assignee: DELGOTI, INC., Boca Raton, FL (US)

(21) Appl. No.: 12/886,623

(22) Filed: Sep. 21, 2010

(51) Int. Cl. A47B 81/06; A47G 1/00; E05B 47/00; A47B 81/00; E05B 65/06

(52) U.S. Cl. 312/7.1; 312/326; 70/78; 312/227

(57) ABSTRACT

A jewelry cabinet and system for storing and concealing jewelry are provided, which may include a foundation element and a frame affixed to it, which together define a compartment. The frame extends a distance outward beyond the compartment, and has a depth at least equal to a sum of the compartment depth and the foundation element thickness. A door is coupled to the frame with a hinge, movable between closed and open positions. The frame distance, the frame depth, and the door in the closed position substantially conceal the presence of the compartment. A plurality of jewelry holders may be affixed to the foundation element.

### CROSS-REFERENCE TO RELATED APPLICATION

N/A

### STATEMENT REGARDING FEDERALLY SPONSORED RESEARCH OR DEVELOPMENT

N/A

### FIELD OF THE INVENTION

The present invention relates to a jewelry cabinet and associated systems for storing and concealing jewelry.

### BACKGROUND OF THE INVENTION

Jewelry continues to be a coveted luxury item, and is one of the most prevalent personal accessories for daily wear and special occasions. It may be purchased personally or as a gift, such as to commemorate an event or milestone, and many people have gathered a collection of many jewelry pieces. Accordingly, jewelry represents a substantial industry. In 2008 for example, jewelry sales in the United States generated revenues of more than $50 billion dollars.

The various types, designs, arrangements, shapes and sizes also continue to proliferate, often resulting in an unwieldy jumble of valuable and sentimental items which present a challenge to store and organize them. Due to the general intricacy and delicacy of many pieces of jewelry, they may tend to become tangled, intertwined, kinked, intermingled, or even knotted. Necklaces and bracelets may be particularly susceptible to this challenge. Also due to the relatively small size of some jewelry, such as for example rings, earrings, pins, lockets, bangles, etc., jewelry may be misplaced or separated from a matching item. Security of jewelry is another concern, because it is valuable, portable, concealable, and generally convertible into cash.

Various cabinets, chests, and systems exist for storing, organizing, securing, selecting, and trying on jewelry. However, most jewelry cabinets are insufficient in one or more desirable aspects. Jewelry cabinets are often too small or much too large, occupy too much counter space, offer rudimentary organization, or present a series of small drawers which merely multiplies the number of tangled pieces of jewelry. From a security perspective, jewelry cabinets tend to have minimal or no security features such as a flimsy lock or latch, or are bulky and unwieldy safes which require alteration and possibly even demolition and reinforcement of a wall.

In addition, many jewelry cabinets are obvious in appearance and are not concealed in any way, presenting a temptation for any household visitors, contractors, assistants, nannies, cleaning services, and repair and maintenance personnel. Some jewelry cabinets conceal the jewelry inside from sight, but the existence of an inner compartment is obvious to a casual observer. For example, handles, knobs, locks, latches, seams, or hinges may be visible even when the cabinet is closed, indicating a compartment is inside. As another example, if the sides of the cabinet are perpendicular to the front face of the cabinet, or have an unusually steep visual angle, the existence of a compartment is evident. Accordingly, the jewelry inside may be visually concealed, but the presence of a compartment is apparent, prompting further unwanted examination of the jewelry cabinet.

It is therefore desirable to provide a jewelry cabinet or jewelry system to store, organize, secure, and conceal the presence of jewelry.

It is also desirable to disguise the jewelry cabinet as another aesthetically attractive household object, to enable storage and organization of various types, designs and sizes of jewelry, and to facilitate trying on and evaluating jewelry pieces among a collection.

### SUMMARY OF THE INVENTION

The present invention advantageously provides a jewelry cabinet and system for storing and concealing jewelry. In one embodiment, the jewelry cabinet includes a foundation element having a thickness, and a frame affixed to the foundation element, the foundation element and frame defining a compartment having a depth. The frame extends a distance outward beyond the compartment, and the frame has a depth at least equal to a sum of the compartment depth and the foundation element thickness. A door is coupled to the frame with a hinge, movable between a closed position and an open position. The frame distance, the frame depth, and the door in the closed position substantially conceal the presence of the compartment. A plurality of jewelry holders are affixed to the foundation element.

In another embodiment, a system for storing and concealing jewelry includes a jewelry cabinet with a foundation element having a thickness, and a frame affixed to the foundation element, the foundation element and frame defining a compartment having a depth. The frame extends a distance outward beyond the compartment, and the frame having a depth at least equal to a sum of the compartment depth and the foundation element thickness. A door is coupled to the frame with a hinge, movable between a closed position and an open position. The frame distance, the frame depth, and the door in the closed position substantially conceal the presence of the compartment. A magnetically actuatable lock is affixed to either the door or the frame, and a plurality of jewelry holders are affixed to the foundation element. The system also includes a magnetic key fob operable to release the lock.

In yet another embodiment, the jewelry cabinet includes a foundation element having a thickness, and a frame affixed to the foundation element, the foundation element and frame defining a compartment having a depth. The frame extends a distance outward beyond the compartment, and the frame has a depth at least equal to a sum of the compartment depth and the foundation element thickness. A door is coupled to the frame with a hinge, movable between a closed position and an open position. An electronic lock having a radiofrequency identification mechanism is affixed to either the door or the frame. In the closed position, the door conceals the hinge, lock, and foundation element. The jewelry cabinet further has a plurality of jewelry holders affixed to the foundation element.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein:

FIG. 1 is a perspective illustration of an exemplary jewelry cabinet in accordance with the principles of the present invention;

FIG. 2 is a perspective illustration of the jewelry cabinet of FIG. 1, showing the door in an open position;

FIG. 3 is a perspective illustration of an interior locking mechanism in accordance with the principles of the present invention;

FIG. 4 is a perspective illustration of an interior latch in accordance with the principles of the present invention;

FIG. 5 is a side elevation illustration of the jewelry cabinet of FIG. 1, showing the door in a closed and locked position;

FIG. 6A is a top view illustration of the jewelry cabinet of FIG. 1, showing the door in a closed and locked position and an exemplary unlocking fob;

FIG. 6B is a top view illustration of the jewelry cabinet of FIG. 1, showing use of a fob to unlock the door;

FIG. 6C is a top view illustration of the jewelry cabinet of FIG. 1, showing opening the door;

FIG. 7 is an elevation illustration of an exemplary jewelry cabinet in accordance with the principles of the present invention;

FIG. 8 is an elevation illustration of another exemplary jewelry cabinet in accordance with the principles of the present invention; and

FIGS. 9A-D are cross-section illustrations of various exemplary frames of jewelry cabinets in accordance with the principles of the present invention.

### DETAILED DESCRIPTION OF THE INVENTION

The present invention provides jewelry cabinets and systems to store, organize, secure, and conceal the presence of jewelry. Referring now to the drawings in which like reference designators refer to like elements, there is shown in FIG. 1 an exemplary embodiment of a jewelry cabinet, designated generally as 10. Of note, the device components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the system and devices disclosed herein may be included in a variety of different combinations or configurations without departing from the scope and spirit of the invention.

As shown in FIG. 1, the jewelry cabinet 10 generally includes an outer frame 12 and a door 14. To conceal the presence of jewelry inside the jewelry cabinet 10, the appearance of the jewelry cabinet 10 may be disguised as any suitable household object, such as for example a decorative mirror affixed to a household wall, a painting or picture with an ornate frame, or some other artwork such as an etching, carved relief, etc.

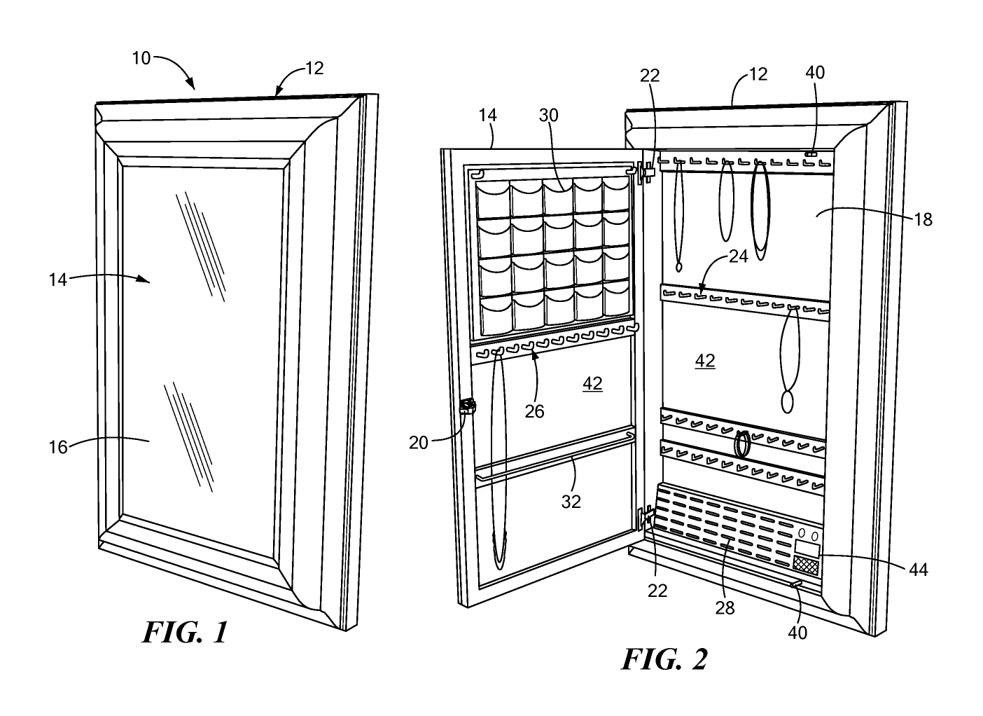

The jewelry cabinet 10 is shown with greater detail in FIG. 2, and may include the frame 12, the door 14, a foundation element 18, a lock 20, one or more hinges 22, a first plurality of jewelry holders 24, a second plurality of jewelry holders 26, a plurality of ring slots 28, a plurality of pouches 30, and a restraining element 32.

The foundation element 18 may be generally planar or have other shapes and dimensions, for example having an inner surface, an outer surface, and a thickness 46. The foundation element 18 may define the back of the jewelry cabinet 10. An inner compartment 48 is defined within the jewelry cabinet 10, for example within the boundaries of the frame 12 and the foundation element 18. Alternatively, the inner compartment 48 may be defined fully or in part by additional members such as inner panels. The inner compartment 48 has dimensions including a height, width, and depth 50. To aid in disguising the jewelry cabinet 10 as an innocuous household object, the size of the inner compartment 48 may be configured to avoid causing any ‘protrusion’ from the back. For example, the frame 12 may have a depth 52 at least equal to a sum of the compartment depth 50 and the foundation element thickness 46, so that the frame is sufficiently deep to contain and conceal the size of the inner compartment.

Various components may be affixed to the foundation element 18, including for example the frame 12, first set of jewelry holders 26, and a ring holder with a plurality of ring slots 28. The jewelry holders 26 may have various features and shapes, ranging from the hooks shown in the drawings to posts, clasps, tree structures, foam inserts having shaped cutouts, drawers, etc. Of course, all of the items for storing and organizing jewelry inside the jewelry cabinet 10 may be arranged as desired in a wide variety of configurations, including positioning jewelry holders on the foundation element 18, the door 14, and even the frame 12, placing the pouches 30 and the ring slots 28 as shown or in other positions, arranging various components in different rows, etc. The jewelry holders 26 affixed to the inner surface of the foundation element 18 may be arranged in at least two horizontal rows, separated by a vertical distance. The ring holder may be made of resilient or foam material.

The outer surface of the foundation element may include one or more mounting elements 34, for example hardware such as bolts, anchors or other fasteners shown in FIG. 5. Alternatively, the foundation element 18 may have openings with flanges to receive hardware such as bolts, anchors or other fasteners, which may be used to securely mount the jewelry cabinet 10 to a household wall.

Material selection for the foundation element, and all the components of the jewelry cabinet 10, may be made with a view to desirable properties, including strength, weight, shape, finish, a solid feel, color, pattern and quality. The foundation element 18 may be made of various materials, including for example metals, wood, or possibly even laminar structures or certain polymers. The materials selected for the foundation element 18 should be suitably strong, for example hardwoods or metals such as steel.

The door 14 has an outer surface which may have a beveled mirror or picture 16 as depicted in FIG. 1, or any other desired aesthetic feature to conceal the functional aspects of the jewelry cabinet 10 and particularly its contents. Various components may be affixed to the inner surface of the door 14, including for example the second plurality of jewelry holders 26, the plurality of pouches 30, and the restraining element 32. The second plurality of jewelry holders 26 again may be the illustrated hooks or a variety of different shapes and designs. The restraining element 32 may also have a variety of possible shapes and designs, including for example an angular bracket with a horizontal member separated by a distance from the inner surface of the door 14, or a ribbon or other flexible restraining element. In the configuration depicted in FIG. 2, the jewelry holders 26 and the restraining element 32 may be arranged to accommodate long necklaces hung on the jewelry holders 26 and extending down behind the restraining element 32. Alternatively, at least one end of the restraining element 32 may be removably affixed to the door 14.

The plurality of pouches 30 may be provided, in particular for smaller jewelry items like earrings, brooches and pins. In FIG. 2, the pouches 30 may be affixed to the door 14 or may be removable. The material of the pouches 30 may be flexible and supple, including for example fabrics, and may be translucent or transparent to more easily see which items are in each pouch.

The hinges 22 connect the door 14 to the frame 12, such that the door is movable between a closed position and open positions. The hinges 22 may have a mechanism to allow smooth stable movement of the door without slack, and may be designed so that the entire hinge 22 is concealed by the door in the closed position.

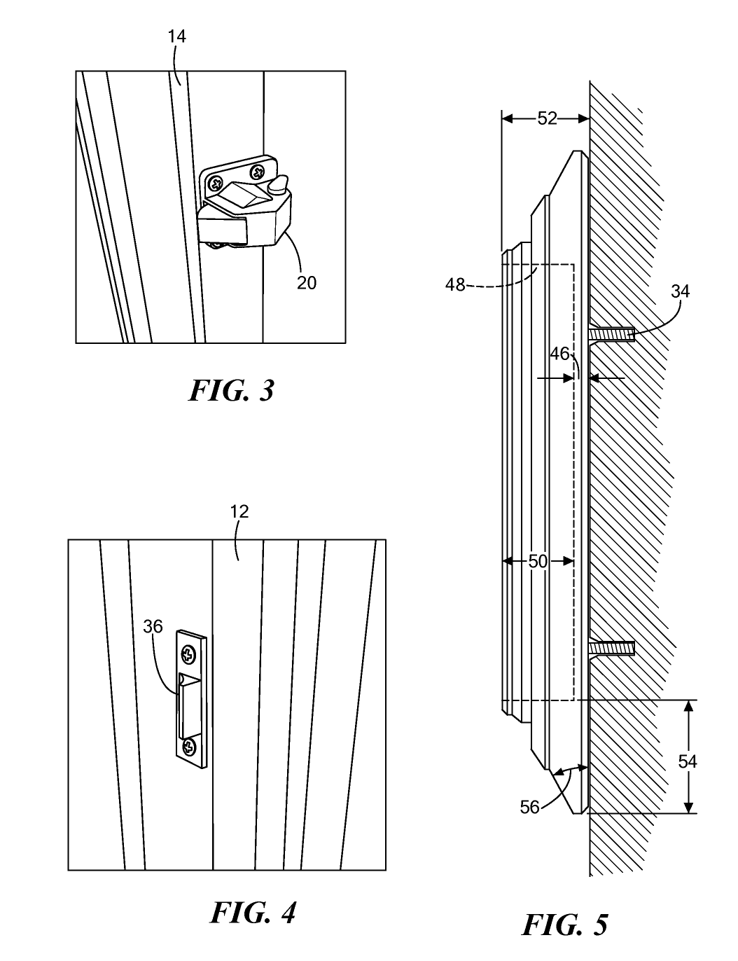

The lock 20 may be affixed to the door as shown in FIG. 3 or may be affixed to the frame 12, releasably locking the door 14 in the closed position by engaging a latch 36. As shown in FIG. 4, the latch 36 may be affixed to the frame 12. If the lock 20 is affixed to the frame 12, the latch 36 should be affixed to the door 14. Various types of locks may be used, with or without various types of latches or other engaging members. Regardless of the selection of hinges and locking mechanisms, when the door is in the closed position, it should conceal the foundation element 18, the lock 20, and the hinges 22. This concealment of the jewelry cabinet components hides the existence of the inner compartment and the jewelry stored inside.

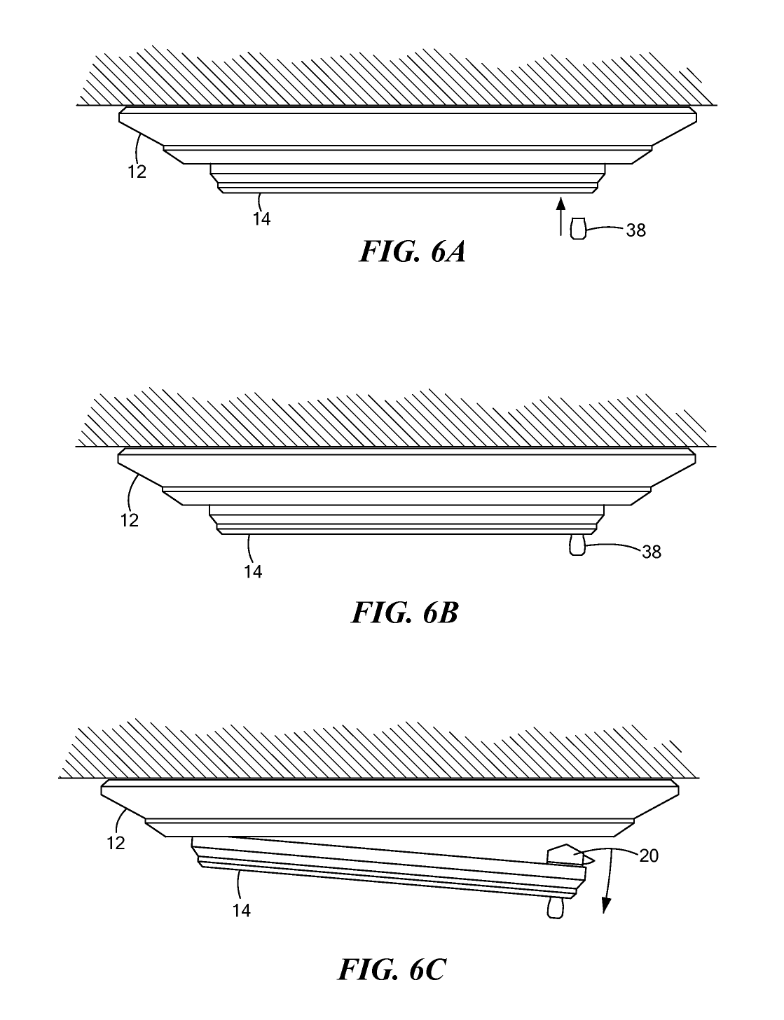

The lock may be magnetically actuatable, such as for example by a magnetic key fob 38. As shown in FIGS. 6A-C, key fob 38 may be placed in proximity to the lock 20 which is not visible when the door is closed, thus disengaging the lock 20. Then the door may be opened in the direction shown by the arrow in FIG. 6C.

The frame 12 surrounds and is affixed to the foundation element 18, and may have a wide variety of shapes, sizes, designs, colors, patterns and materials. The cross-sectional shape of the frame 12 may be selected for the purpose of disguising the jewelry cabinet 10 as a household object such as for example a wall mirror or frame painting or picture. The cross-section of the frame 12 should also be selected to conceal the existence of the inner compartment 48 of the jewelry cabinet 10, with a front surface that generally defines a slope from a thicker inner cross-section to a thinner outer cross-section. This general shape gives the appearance of merely a decorative frame, while defining sufficient depth for the inner compartment 48.

In addition to concealing the inner compartment 48 and its contents from sight, the jewelry cabinet 10 is also designed to conceal the very presence of the inner compartment 48. In other words, furniture in general including for example a cabinet, chest, credenza, cupboard, dresser, nightstand, or wardrobe is often configured to conceal their internal chambers and contents from sight. However, they do not conceal the presence of the internal chambers, since it is apparent to a casual observer that furniture doors and drawers have such spaces to store objects and apparel. In contrast, the jewelry cabinet 10 obscures whether there is any inner compartment 48.

As shown in FIGS. 1 and 2, the frame 12 has a four-sided rectangular shape with a series of four chamfered corners, though of course it may also have a square, polygonal, rounded, elliptical, circular, or other desired shape. The frame 12 extends outward beyond the boundaries of the inner compartment 48, for example a distance above and below the height of the inner compartment 48, and another distance left and right of the width of the inner compartment 48. A frame distance 54, the frame depth 52, and the door 14 in the closed position may cooperate to substantially conceal the presence of the inner compartment 48. The frame 12 presents a visual angle relative to the back of the jewelry cabinet 10 or a wall on which it hangs, and that angle should be configured so the frame 12 appears to be merely a frame. For example, if the angle is too shallow, either the frame distance 54 will be so great as to make the presence of the inner compartment 48 apparent, or the frame depth 52 will leave insufficient room for an inner compartment 48 of acceptable size. On the other hand, if the angle is too steep, the presence of the inner compartment 48 would also be obvious. As a specific example, a visual angle 56 of the frame 12 may range from approximately 30 degrees to 60 degrees. Accordingly, a ratio of the sum of the inner compartment depth 50 and the foundation element thickness 46 divided by the distance 54 that the frame 12 extends outward beyond the inner compartment 48 may range from approximately 0.5 to 1.7.

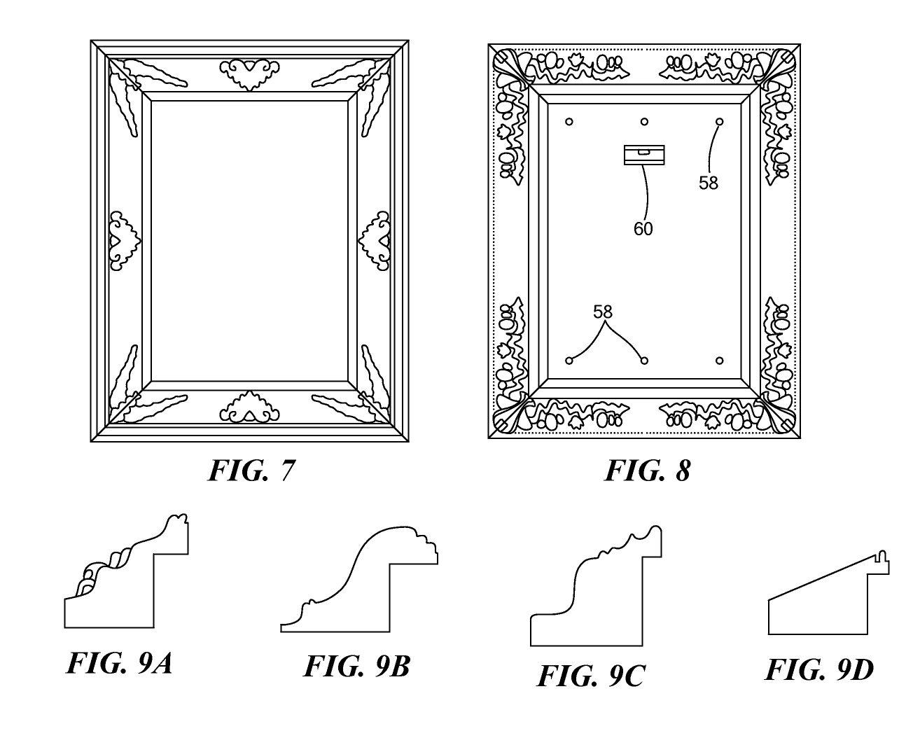

The frame 12 may also be relatively simple or elegant design, or a relatively ornate, textured or sculpted design. In FIGS. 1 and 2, the frame 12 has a contoured cross-section with a few rounded plateaus. In FIGS. 7 and 8, the frames are more ornate and decorative. Some possible cross-sections of the frame are illustrated in FIGS. 9A-9D, including a sculpted cross-section in FIG. 9A, a sloping rounded cross-section in FIG. 9B, a multi-contoured cross-section in FIG. 9C, and a relatively simple beveled cross-section in FIG. 9D.

The frame may also have a first and second spring pusher 40, biasing the door in the opening direction. For example, spring pushers 40 may have a dormant condition when fully depressed, and an active spring condition activated upon a subsequent press inward on the door 14. The spring pushers 40 may alternatively be mounted on the door.

The inner surfaces of the foundation element 18 and the door 14 may be covered with a liner 42, padded upholstery or other suitable covering. The material properties of the fabric liner 30 may be selected to avoid scratching or damaging the jewelry, and also to present a luxurious surface. Among many possible materials, various fabrics may be used such as for example satin, cotton or felt.

Alternatively, the jewelry cabinet 10 may include other aesthetic features, including a music player 44.

Another possible aspect may include various features for preserving jewelry, including avoiding tarnishing. For example, the liner 42, fabrics and other surfaces may be made of anti-tarnishing materials. The inner compartment 48 may also have a controlled environment, such as low humidity or constant humidity. The door 14 may even have a seal, and the inner compartment 48 may have a non-air environment, to better preserve the jewelry in pristine condition.

In an alternative aspect with additional security, the lock may be electronic. For example, an electronic lock may require an electronic coded key fob. Alternatively, the lock may have a radiofrequency identification (known as “RFID”) mechanism which can be opened in only when a specific radiofrequency identification key or card is in proximity to the lock.

Yet another alternative aspect is a mounting system which facilitates mounting the jewelry cabinet to a wall. A template may be provided for aiding proper positioning and alignment of the jewelry cabinet, and placement of fasteners or mounting elements for securely affixing the jewelry cabinet. For example, the template may have guides 58 for drilling or indicating desired positions of fastening members such as wall anchors, and an optional bubble level 60 may be affixed to the template to aid in obtaining a level installation, as shown in FIG. 8.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A jewelry cabinet, comprising:
a foundation element having a thickness;
a frame affixed to the foundation element, the foundation element and frame defining a compartment having a depth, the frame extending a distance outward beyond the compartment, the frame having a depth at least equal to a sum of the compartment depth and the foundation element thickness;
a door coupled to the frame with a hinge, the door being movable between a closed position and an open position;
the frame distance, the frame depth, and the door in the closed position substantially concealing the presence of the compartment; and
a plurality of jewelry holders affixed to the foundation element.

2. The jewelry cabinet of claim 1, the frame having a beveled surface, such that an inner portion of the frame is thicker than an outer portion of the frame.

3. The jewelry cabinet of claim 1, wherein a ratio of the sum of the compartment depth and the foundation element thickness divided by the distance the frame extends outward beyond the compartment ranges from 0.5 to 1.7.

4. The jewelry cabinet of claim 1, further comprising a lock and a latch, each affixed to one of the door and the frame, releasably locking the door in the closed position.

5. The jewelry cabinet of claim 2, the door in the closed position concealing the hinge, lock, latch, and foundation element.

6. The jewelry cabinet of claim 2, wherein the lock is magnetically actuatable.

7. The jewelry cabinet of claim 1, wherein the lock is electronic.

8. The jewelry cabinet of claim 1, further comprising at least one spring member affixed to one of the door and the frame, biasing the door in an opening direction.

9. The jewelry cabinet of claim 1, further comprising a restraining element coupled to the door and having a substantially horizontal member positioned a distance from an inner surface of the door.

10. The jewelry cabinet of claim 9, wherein at least one end of the restraining element is removably affixed to the door.

11. The jewelry cabinet of claim 1, further comprising a ring holder of resilient material having a plurality of ring slots.

12. The jewelry cabinet of claim 1, further comprising a plurality of pouches removably coupled to one of the door and the foundation element.

13. The jewelry cabinet of claim 12, wherein an inner portion of the plurality of pouches is translucent.

14. The jewelry cabinet of claim 1, further comprising a fabric liner covering an inner surface of the foundation element and a fabric liner covering an inner surface of the door.

15. The jewelry cabinet of claim 1, wherein the outer surface of the door further comprises a minor.

16. The jewelry cabinet of claim 1, wherein the outer surface of the door further comprises a picture.

17. The jewelry cabinet of claim 1, further comprising a music player.

18. A system for storing and concealing jewelry, comprising:
a jewelry cabinet having:
a foundation element having a thickness;
a frame affixed to the foundation element, the foundation element and frame defining a compartment having a depth, the frame extending a distance outward beyond the compartment, the frame having a depth at least equal to a sum of the compartment depth and the foundation element thickness;
a door coupled to the frame with a hinge, the door being movable between a closed position and an open position;
the frame distance, the frame depth, and the door in the closed position substantially concealing the presence of the compartment;
a magnetically actuatable lock affixed to one of the door and the frame;
a plurality of jewelry holders affixed to the foundation element; and
a magnetic key fob operable to release the lock.

19. The system of claim 18, further comprising a mounting element, and a template having a level and a guide indicating a desired position for the mounting element.

20. A jewelry cabinet, comprising:
a foundation element having a thickness;
a frame affixed to the foundation element, the foundation element and frame defining a compartment having a depth, the frame extending a distance outward beyond the compartment, the frame having a depth at least equal to a sum of the compartment depth and the foundation element thickness;
a door coupled to the frame with a hinge, the door being movable between a closed position and an open position;
an electronic lock having a radiofrequency identification mechanism affixed to one of the door and the frame;
the door in the closed position concealing the hinge, lock, and foundation element; and
a plurality of jewelry holders affixed to the foundation element.
